(19) United States
(12) Patent Application Publication
(10) Pub. No.: US 2010/0307019 A1
(43) Pub. Date: Dec. 9, 2010

(54) DRYING APPARATUS FOR PET

(75) Inventors: Beoung Chel Park, Seoul (KR); Won Seok Kang, Seoul (KR)

Correspondence Address: CANTOR COLBURN LLP, 20 Church Street, 22nd Floor, Hartford, CT, 06103, US

(73) Assignee: ETIRA CO., LTD., Suwon-si (KR)

(21) Appl. No.: 12/743,985

(22) PCT Filed: Jul. 28, 2008
(86) PCT No.: PCT/KR08/04392

§ 371 Date: May 20, 2010

(30) Foreign Application Priority Data
Nov. 21, 2007 (KR) 10-2007-0118922
Jun. 7, 2008 (KR) 10-2008-0053414

(51) Int. Cl. F26B 19/00

(52) U.S. Cl. 34/90

(57) ABSTRACT

The present invention provides a cross-flow type drying apparatus for a pet, that is capable of quickly performing drying by blowing air uniformly on the entire body of a pet and simultaneously facilitating drying by reducing the amount of stress that a pet is subjected to. The cross-flow type drying apparatus includes: a main body case defining an outlet and an inlet and including a heating member installed within; a cross-flow fan installed in a longitudinal direction within the main body case to rotate; and a stand coupled to enable the main body case to pivot to a predetermined angle. This configuration can reduce drying time and easily perform drying the pet, and can lower manufacturing cost to reduce the financial burden placed on a user.

### TECHNICAL FIELD

The present invention relates to a drying apparatus for a pet, and more particularly, to a drying apparatus for a pet, which is capable of quickly performing drying by blowing air uniformly on the entire body of a pet and simultaneously facilitating drying by reducing the amount of stress that a pet is subjected to.

### BACKGROUND ART

Currently, a lot of households keep pets such as dogs and cats, and while pets are sources of pleasure for people, they can also become sources of diseases and odors if hygienic care—especially regular baths—are not administered. Furthermore, fur, foreign substances, etc. from pets become contaminants of surrounding environments.

Accordingly, people who keep pets must regularly bathe their pets. In general, the process of bathing a pet involves putting the pet into a tub filled with water, holding the pet with one hand to prevent water entering the pet's eyes, nose, and mouth and pouring water with the other hand or using a shower head to bathe the pet, after which the pet's wet fur is dried.

Here, if a pet (whose entire body is covered with fur) is not properly and expediently dried following a bath, the pet is made susceptible to skin diseases because its skin is much weaker than a person's, or the pet may begin to smell. However, pets have a strong aversion to being dried after a bath. This is because hair dryers that are used by people are usually employed, which causes aversion in pets for the following reasons.

First, due to weight considerations, a typical hair dryer that is used hand-held employs a small motor that rotates at high speed to blow air, thus generating ultra-high frequency sound inaudible to humans, but highly audible and disconcerting for pets. That is, such noise is sufficient in instill tenor in pets that have a sense of hearing more sensitive than a human's by five times or greater.

Second, the temperature at the outlet of a hair dryer used by humans is high at approximately 55° C. However, because the skin of a pet that is covered with fur is frail, when hot air of a high temperature generated from a hair dryer is discharged directly onto a pet, this can cause great discomfort for the pet. In particular, because immature pets are more sensitive, they will not forget their initial experience of being subjected to hot air from a hair dryer, and will subsequently be unwilling to undergo being dried again with a hair dryer. Therefore, there is the problem of users experiencing difficulty in drying their pets after bathing them.

Third, in the case of some pets who have a double coat, when a general hair dryer is used to topically apply heat to dry fur, the fur is characterized by regions thereof that have and have not been subjected to hot air extending haphazardly in different directions or becoming dishevelled. Also, the hair driver employs an axial fan, and has a circular outlet with a diameter of typically 6-7 cm. Accordingly, because hot air that is generated is discharged through the narrow outlet topically (over a limited area) onto a pet, the dryer must be moved this way and that to perform drying. As a result, because the overall drying time is prolonged (typically lasting 30 to 60 minutes), both the person and the pet become fatigued, and there is also the problem of pets with fragile respiratory systems easily succumbing to respiratory ailments.

Fourth, due to the above problems, many users have resorted to entrusting the maintenance of the cleanliness of their pets to shops that specialize in grooming. However, given that this is regularly done, it involves the drawback of high expenditures.

### DISCLOSURE OF INVENTION

### Technical Problem

To meet requirements arising from the above problems, an object of the present invention is to provide a drying apparatus for a pet that is capable of quickly performing drying by blowing air uniformly on the entire body of a pet and simultaneously facilitating drying by allowing a user to freely use both hands.

Another object of the present invention is to provide a drying apparatus for a pet that is not only capable of controlling the temperature and quantity of discharged air to levels suitable for pets, but is also particularly capable of providing an ample quantity of discharged air to facilitate quick drying, while emitting low operating noise.

### Technical Solution

To obviate the problems described above, there is provided a drying apparatus for a pet, which discharges air to dry fur of a pet, the drying apparatus including: a main body case defining an outlet and an inlet and including a heating member installed within; a cross-flow fan installed in a length direction within the main body case, and rotated by a fan motor; and a stand supporting the main body case in a continuous state, and provided with a manual knob for pivoting the main body case to a predetermined angle.

The manual knob may include a tension ball installed in a side surface thereof and elastically supported to be partially exposed to an outside, and the stand may include a plurality of latching recesses defined at predetermined intervals along a side surface of the stand to correspond to and seat the tension ball.

Also, there is provided a drying apparatus for a pet, which discharges air to dry fur of a pet, the drying apparatus including: a main body case provided with an air outlet and a heating member within; a rotating fan installed within the main body case and rotated by a fan motor; and a stand supporting the main body case in a continuous state, and provided with a pivoting supporting member capable of automatic or manual pivoting of the main body case upward and downward.

In addition, there is provided a drying apparatus for a pet, which discharges air to dry fur of a pet, the drying apparatus including: a main body case provided with an air outlet and a heating member within; a rotating fan installed within the main body case and rotated by a fan motor; and a stand defining a plurality of latching recesses at predetermined intervals, wherein the main body case is provided with a tension ball in a side surface thereof to be partially exposed to an outside, and the latching recesses are defined to correspond to and seat the tension ball, such that the main body case is pivotable by a predetermined angle.

The drying apparatus may further include a swing motor installed on one end of the main body case to automatically pivot the main body case.

The rotating fan may be a sirocco fan installed in a longitudinal direction to rotate in the main body case.

The stand may include a tension ball installed in a side surface thereof to be elastically supported and partially exposed to an outside, and the main body case may define a plurality of latching recesses at predetermined intervals on a side surface thereof to correspond to and seat the tension ball, such that the pivoting supporting member is manually operated.

The stand may be provided with a controlling member enabling vertical height adjustment or lateral pivoting of the stand.

The stand may be provided with an electronic controlling member.

The stand may include: a bridge stand supporting the main body case, and provided with an air inlet; and a floor stand having the electronic controlling member built in.

The drying apparatus may further include a sanitary filter provided at a front of the air inlet.

### Advantageous Effects

First, by using the benefits of a rotating fan that can discharge air over an extended width to uniformly discharging air over the entire body of a pet (approximately 30-40 cm wide in the case of a typical lapdog), the present invention can achieve the effects of expediting drying while at the same time reducing fatigue from a prolonged drying process to a person and a pet, and also obviating a pet contracting a respiratory ailment.

Second, the present invention may be used in a floor-standing configuration, allowing a user to use both hands to dry a pet, thus facilitating drying.

Third, instead of using a typical ±5-watt miniature motor (that is rotated at a high speed of 10,000-15,000 rpm and generates a high level of noise including ultrasonic frequencies) employed in hair dryers, the present invention uses a motor of ±40 W that rotates a rotating fan comparatively slowly at ±2,000 rpm (because the design of the floor-standing apparatus is not particularly dependent on the weight of the motor), so that the noise level is substantially decreased to have the effect of reducing the amount of stress that a pet receives during a drying process.

Fourth, because product cost can be reduced by simplifying the structure of the apparatus of the present invention, there is the economic benefit in that users are able to use the product without experiencing financial burden.

### BRIEF DESCRIPTION OF THE DRAWINGS

FIG. 1 is a frontal view illustrating the structure of a cross-flow drying apparatus for a pet according to a first embodiment of the present invention,

FIG. 2 is a state diagram schematically illustrating the operation of a cross-flow drying apparatus for a pet according to the first embodiment of the present invention,

FIG. 3 is a schematic view illustrating the structure of a cross-flow drying apparatus for a pet according to the first embodiment of the present invention,

FIG. 4 is a schematic view illustrating the structure of a cross-flow drying apparatus for a pet according to a second embodiment of the present invention,

FIG. 5 is a schematic view illustrating the structure of a cross-flow drying apparatus for a pet according to a third embodiment of the present invention,

FIG. 6 is an enlarged view of a portion A-A in FIG. 5,

FIG. 7 is state diagram illustrating the structure of a drying apparatus for a pet according a fourth embodiment of the present invention,

FIG. 8 is a partial sectional view of a drying apparatus for a pet according to the fourth embodiment of the present invention,

FIG. 9 is an operating state view of a drying apparatus for a pet according to the fourth embodiment of the present invention,

FIG. 10 is a schematic view illustrating the structure of a portion of a drying apparatus for a pet according to the fourth embodiment of the present invention,

FIG. 11 is a schematic view illustrating the structure of a swing motor of a drying apparatus for a pet according to the present invention,

FIG. 12 is a schematic view illustrating the structure of a tension ball of a drying apparatus for a pet according to the present invention,

FIG. 13 is a schematic view illustrating lateral rotation of a drying apparatus for a pet according to the present invention, and

FIG. 14 is a schematic view illustrating a height adjusting member formed on the undersurface of a stand of a drying apparatus for a pet according to the present invention.

### MODE FOR THE INVENTION

A detailed description of preferred embodiments of the present invention will be given below with reference to the drawings. In the assigning of reference numerals to elements in the respective drawings, whenever possible, like reference numerals are used to represent like elements that appear in different drawings.

### First Embodiment

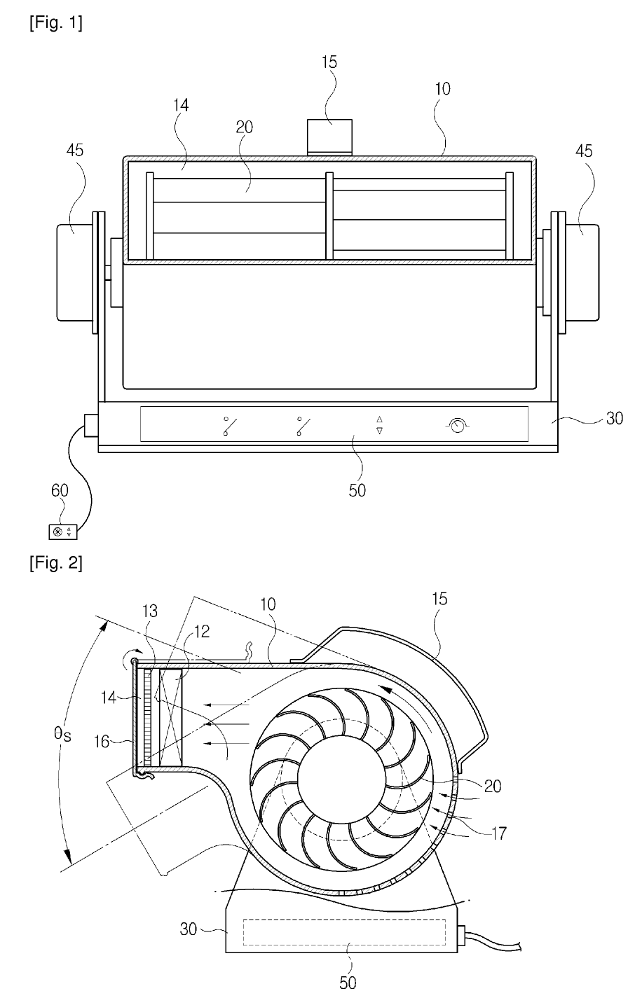

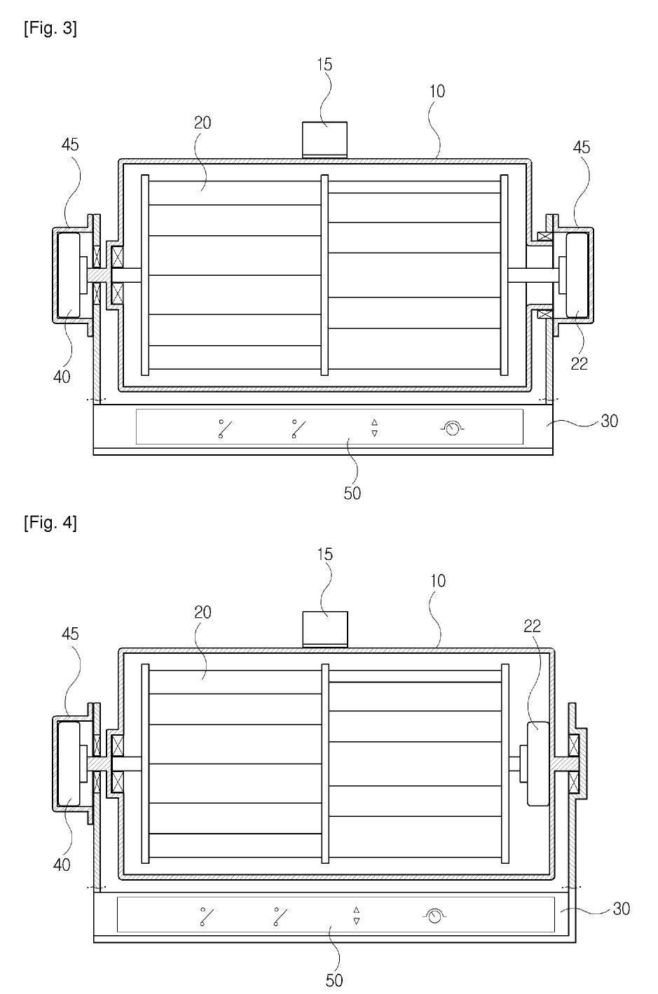

FIG. 1 is a frontal view illustrating the structure of a cross-flow drying apparatus for a pet according to a first embodiment of the present invention, FIG. 2 is a state diagram schematically illustrating the operation of a cross-flow drying apparatus for a pet according to the first embodiment of the present invention, and FIG. 3 is a schematic view illustrating the structure of a cross-flow drying apparatus for a pet according to the first embodiment of the present invention.

As illustrated, a drying apparatus for a pet according to the present invention includes a main body case 10, a cross-flow fan 20, and a stand 30.

The main body case 10 defines a rectangular outlet 14 that projects at one side. A heating member 12 is installed in the inside of the outlet 14. Here, an outlet grill 13 for preventing impurities of a predetermined size from entering may be installed between the outlet 14 and the heating member 12. Also, an outlet cover 16 is hinged to the opening of the outlet 14 to prevent entry of finer impurities such as dust into the outlet 14 during storage, and a torsion spring may be provided at the hinge connecting portion to automatically open the outlet cover 16. Moreover, a handle 15 may be installed on the outside of the main body case 10 to facilitate grasping. Further, in order to allow air to be easily suctioned, a plurality of inlets 17 may be defined over a predetermined area. A filter for preventing suctioning of impurities may be detachably mounted on the inlets 17.

The cross-flow fan 20 is installed in a length direction within the main body case 10. That is, the cross-flow fan 20 functions to discharge air over a predetermined width in a longitudinal direction of the cross-flow fan 20. A shaft at one end of the cross-flow fan 20 is rotatably coupled to the main body case 10, with a bearing (not provided with a reference number in the diagrams) interposed therebetween. A shaft at the other end of the cross-flow fan 20 is connected to a fan motor 22, so that the cross-flow fan 20 is rotated by the driving force of the fan motor 22. The fan motor 22 may be connected to a stepless transmission controller. Thus, a user may finely control the rotating speed of the cross-flow fan 20. Here, the stepless transmission controller may be configured with a typical stepless transmission controlling circuit formed between a controller and the fan motor 22. That is, the rpm of the cross-flow fan 20 can be steplessly controlled by varying the rotation of the fan motor 22 according to a variable resistance value input by a user. As another means, a digitally controlling device may be employed that can finely adjust the rpm through a program whenever an up or down button is pressed to input signals to a control micom. Accordingly, the strength of blown air can be controlled to be suitable for the temperament of a particular pet. By employing a cross-flow fan 20 in the drying apparatus of the present invention, air can be blown at a uniform intensity through an outlet 14 having a predetermined length (longitudinal length). Therefore, by uniformly blowing air during drying along the entire body of a pet, drying efficiency can be increased to enable speedy drying.

One end of the main body case 10 is rotatably coupled to a stand 30 with a bearing (not assigned a reference number in the diagrams) in between. A swing motor 40 fixed to the stand 30 is coupled to the other end of the main body case 10 to pivot the main body case 10 to a predetermined angle. Here, a motor cover 45 may be installed on the swing motor 40 and the fan motor 22. A controller 50 for controlling the swing motor 40 and the fan motor 22 is installed on the lower portion of the stand 30.

Here, a remote controller 60 (in FIG. 1) may be installed on the controller 50 to enable a user to freely control the apparatus from a remote distance. Here, the remote controller 60 may be a typical wired or wireless controller.

The cross-flow drying apparatus for a pet according to the first embodiment of the present invention will be described below in terms of its functions and effects.

First, when power is supplied to the drying apparatus of the present invention, the cross-flow fan 20 is driven inside the main body case 10. Accordingly, a natural breeze or a heated breeze is discharged through the outlet 14 according to a manipulation of the controller 50. The swing motor 40 reciprocally pivots only the main body case 10 (which encloses the cross-flow fan 20 fixed to and rotated by the fan motor 22, and has the inlets 17 and outlet 14) by a predetermined angular range.

In detail, as illustrated in FIG. 2, the pivoting angle (θs) of the main body case 10 is a predetermined angular range over which hot air is reciprocally pivoted and discharged onto the entire body of a pet. Of course, a user is able to fix the main body case 10 at a suitable angle for use as desired.

Thus, because an angle for discharging hot air can be set within a predetermined range or discharging may be performed through automatic pivoting, a user can hold a pet with one hand while using a tool such as a brush with the other hand to arrange hairs (fur) of the pet.

Here, as a method for performing pivoting with the swing motor 40, electrical signals for reciprocal forward/reverse rotation may be applied to a low-speed motor that rotates at low speed (preferably between 4 to 6 rpm), or reciprocal rotation may be achieved within a set range by means of a driving cam or gear assembly. The main body case 10 may be pivoted over a set angular range through a thus-driven swing motor 40 to allow a user to use both hands to dry a pet, thereby facilitating drying and reducing drying time. In other words, in order to blow air over a wide area, the present invention pivots the main body case 10 with the swing motor 40 to automatically control the angular range in which air is discharged.

This is distinctly different in terms of configuration and function from a blown air direction controlling method employed in a typical indoor cooling/heating apparatus. Specifically, a blown air direction controlling method employed in a related art cooling/heating apparatus has a damper grill (or blade) installed at the outlet, whereupon the damper grill is moved upward and downward, so that discharged air collides with the damper grill and is directionally controlled. However, this method involves the drawbacks of reducing discharged pressure and generating noise. Conversely, the blown air direction controlling method of the present invention automatically controls the blown air discharging direction by pivoting the main body case 10 itself within a predetermined angular range with the swing motor 40, so that reduction of discharged pressure of the blown air can be prevented and noise generation can also be prevented. The ability of the present invention to be manufactured in a configuration that employs the swing motor 40 to control the direction of blown air is attributable to its ability to be manufactured in a size smaller than a typical cooling/heating apparatus because of its designation of use for small-sized pets.

Other embodiments of the present invention will be described below with reference to the drawings.

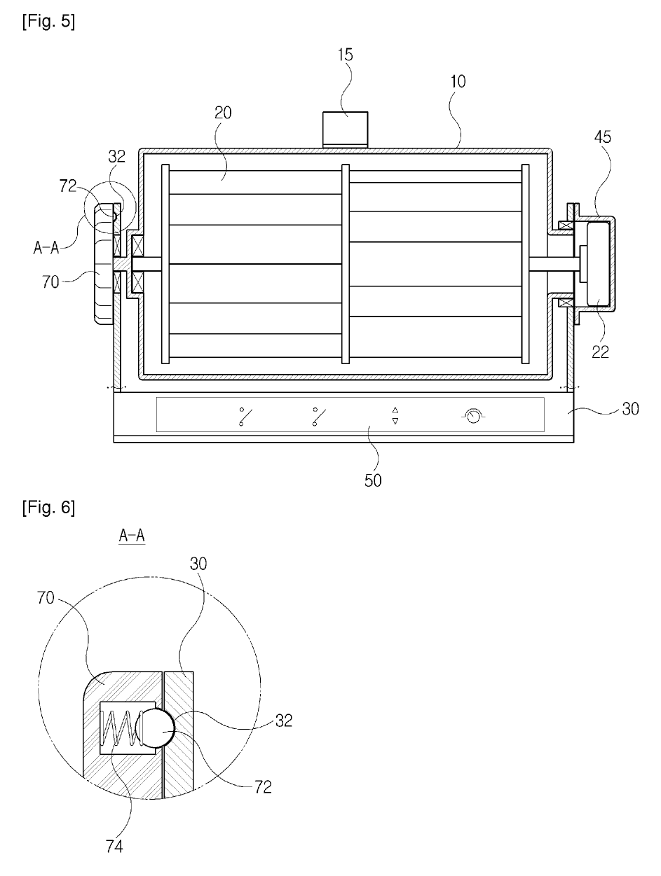

FIG. 4 is a schematic view illustrating the structure of a cross-flow drying apparatus for a pet according to a second embodiment of the present invention, FIG. 5 is a schematic view illustrating the structure of a cross-flow drying apparatus for a pet according to a third embodiment of the present invention, and FIG. 6 is an enlarged view of a portion A-A in FIG. 5.

Referring to FIG. 4, the second embodiment of the present invention may be configured with a fan motor 22 disposed inside a main body case 10. Through this configuration, the exterior of the apparatus can be manufactured in a simpler shape.

Referring to FIGS. 5 and 6, in the third embodiment of the present invention, instead of the swing motor 40 used in the above-described first embodiment to pivot the main body case 10, a manual knob 70 may be installed. While not illustrated in the drawings, the fan motor 22 may be disposed within the main body case 10 as in the second embodiment.

The manual knob 70 may be formed in a size that can be easily grasped by a user, and may be fixed at one end of the main body case 10. In detail, as illustrated in FIG. 6, a tension ball 72 is installed within a side of the manual knob 70 to be elastically supported by a spring 74 with a portion thereof exposed, and a plurality of latching recesses 32 are formed at predetermined intervals in a side surface of the stand 30 such that the tension ball 72 faces and can be seated therein. To dry a pet with this configuration, when a user rotates the manual knob 70 in a desired direction to set the discharging angle, the tension ball 72 is seated in a latching recess 32 to fix the direction of the outlet at a predetermined angle.

That is, the manual knob 70 enables a user to fix the direction of the outlet 14 at a desired angle for use. Accordingly, the cost of the product can be lowered through simplifying the product, and not only the body of a pet, but the pet's feet and extremities can be intensively dried.

Of course, a height adjusting member capable of adjusting vertical height may be provided on the stand 30 to adjust the height of the apparatus (or, the height of the outlet) according to the size of a pet. That is, foldable legs are installed on the floor of the stand 30 to enable height adjustment when required, according to the size of a pet, by folding or extending the foldable legs.

Moreover, because the present invention may be used in a floor-standing state, it can use a mid to large-sized motor with substantially low operating noise. However, the generation of operating noise from even such motors cannot be prevented at the source. Therefore, a separate melody emitting device may be built into the controller 50 for pets that are especially sensitive to such operating noise. The melody emitting device is a well-known device used widely for playback of music or musical therapy. Therefore, the apparatus may be configured to minimize stress from operating noise during drying by playing back relaxing music such as sounds of nature.

### Second Embodiment

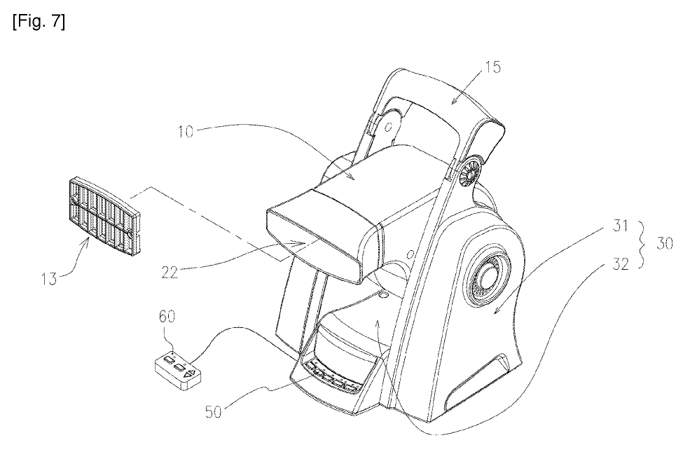

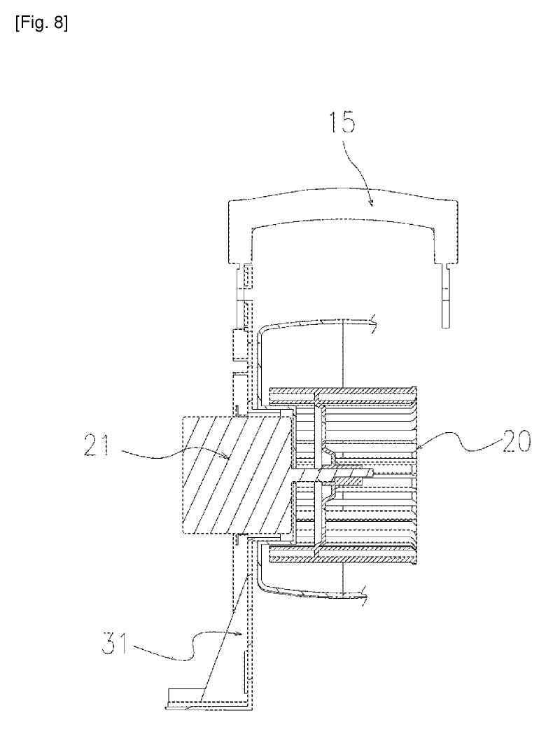

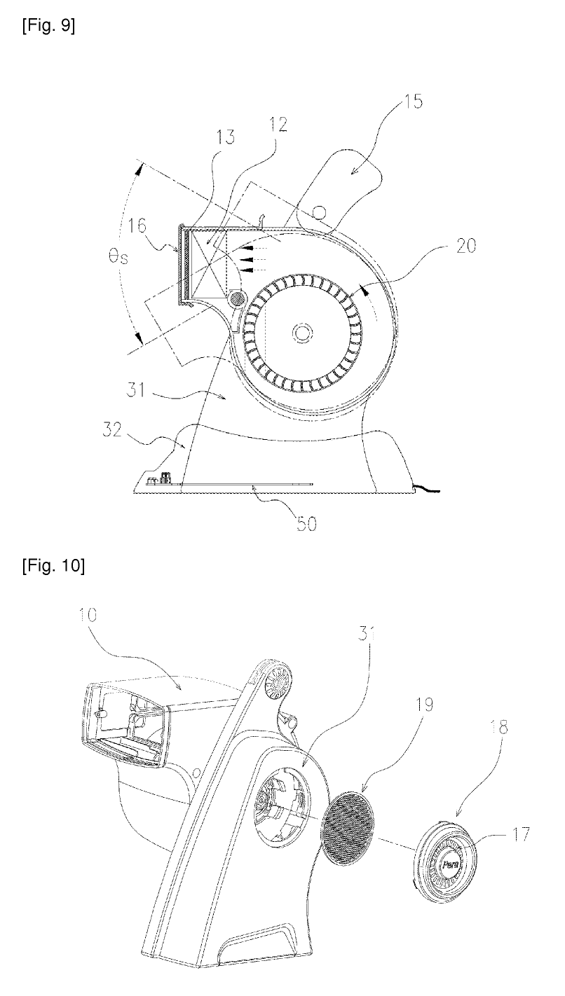

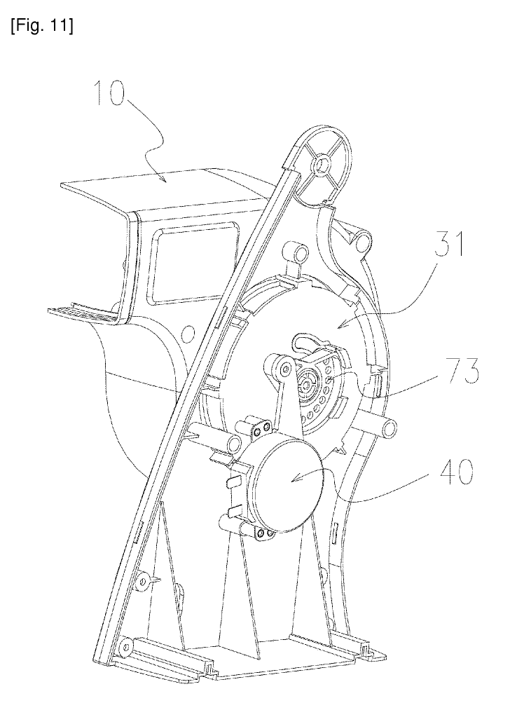

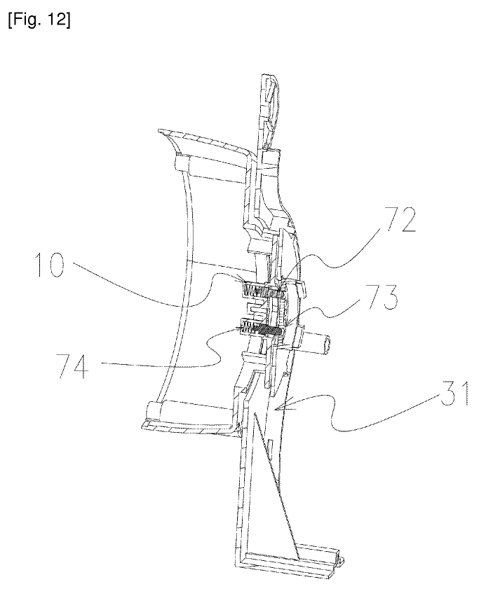

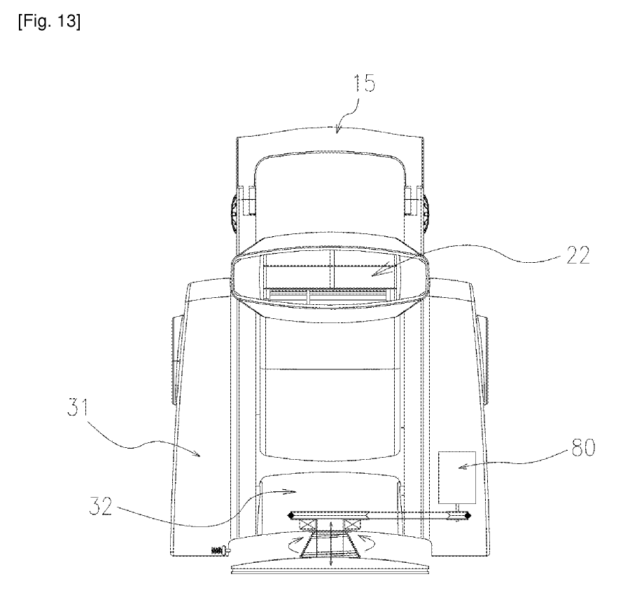

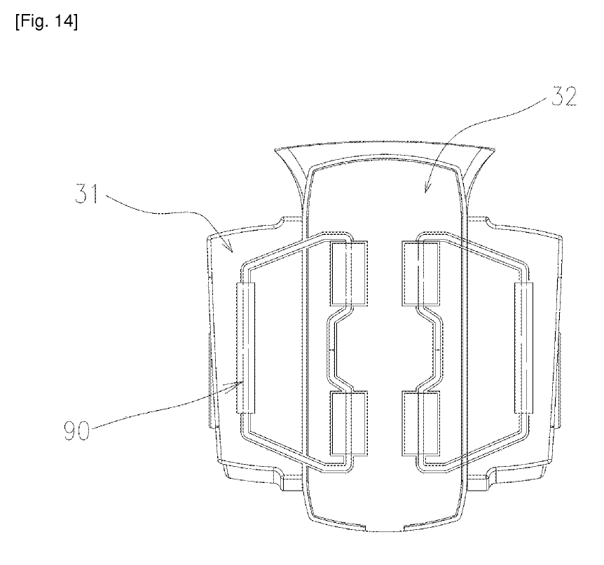

FIG. 7 is state diagram illustrating the structure of a drying apparatus for a pet according a fourth embodiment of the present invention, FIG. 8 is a partial sectional view of a drying apparatus for a pet according to the fourth embodiment of the present invention, FIG. 9 is an operating state view of a drying apparatus for a pet according to the fourth embodiment of the present invention, FIG. 10 is a schematic view illustrating the structure of a portion of a drying apparatus for a pet according to the fourth embodiment of the present invention, FIG. 11 is a schematic view illustrating the structure of a swing motor of a drying apparatus for a pet according to the present invention, FIG. 12 is a schematic view illustrating the structure of a tension ball of a drying apparatus for a pet according to the present invention, FIG. 13 is a schematic view illustrating lateral rotation of a drying apparatus for a pet according to the present invention, and FIG. 14 is a schematic view illustrating a height adjusting member formed on the undersurface of a stand of a drying apparatus for a pet according to the present invention.

As illustrated in the drawings, a drying apparatus for a pet according to the present invention includes a main body case 10, a rotating fan 20, and a stand 30. Specifically, the stand 30 includes a bridge stand 31 and a floor stand 32.

The main body case 10 defines an outlet 22 formed in an approximately rectangular shape projecting to one side. A heating member 12 is installed to the inside of the outlet 22. Here, an outlet grill 13 may be installed between the outlet 22 and the heating member 12 to prevent the entry of impurities greater than a predetermined size. Also, an outlet cover 16 may be hinged to the entrance to the outlet 22 to prevent the infiltration of fine impurities such as dust during storage of the apparatus, and a torsion spring may be interposed at the hinge connection to permit automatic opening. Further, a handle 15 may be installed on the outside of the main body case 10 to facilitate transporting of the drying apparatus according to the present invention by a user. Also, a plurality of inlets 17 (in FIG. 10) may be defined at predetermined spaces to facilitate suctioning of air. A sanitary filter 19 for preventing suctioning of impurities may be removably mounted to the inlets 17.

Referring to FIG. 8, the rotating fan 20 employed may be a centrifugal sirocco fan (multibladed fan) or an axial fan that suctions air in an axial direction and discharges air in a direction perpendicular to the axis, and may be a cross flow fan that suctions/discharges air in directions perpendicular to the axis, to direct air to where a user wants.

Accordingly, in one embodiment of the present invention, the rotating fan 20 is a sirocco fan installed lengthwise inside the main body case 10. That is, the rotating fan 20 functions to discharge cool/hot air across a predetermined width. Here, cool blown air refers to natural blown air, or air that is discharged when the heating device is not used. One axis of the rotating fan 20 is rotatably coupled to the main body case 10, with a bearing (reference numeral not assigned in the drawings) interposed therebetween. Further, the other axis of the rotating fan 20 in FIG. 8 is connected to the fan motor 21, such that the rotating fan 20 is rotated by the driving force of the fan motor 21. Also, a stepless transmission controlling member may be connected to the fan motor 21. Thus, a user may finely adjust the rotating speed of the rotating fan 20. Here, the stepless transmission controlling member may be configured as a stepless transmission control circuit formed between the controller 50 and the fan motor 21. That is, the rotating speed of the rotating fan 20 may be steplessly controlled by varying the rotation of the fan motor 21 according to a variable resistance value input by a user. Another member may be embodied as a digital control device that can finely control rotating speed whenever an “up” or “down” button is pressed, according to a program input to a control micom. Accordingly, the strength of blown air may be adjusted appropriately according to the characteristics of each pet. By thus employing the rotating fan 20 in the drying apparatus of the present invention, air discharged through the outlet 22 having a predetermined length (in a longitudinal direction) may be blown at a uniform strength. Therefore, by blowing air uniformly across the entire body of a pet during drying, drying efficiency can be raised to enable quick drying.

Referring to FIG. 11, to describe the stand 30 in further detail, one end of the main body case 10 is pivotably coupled to the bridge stand 31, with a bearing (not assigned a reference numeral in the drawings) interposed therebetween. The other end of the main body case 10 is connected to a swing motor 40 fixed to the bridge stand 31, to pivot the main body case 10 in a predetermined angular range.

Referring again to FIG. 7, at the lower portion of the stand 30, or more particularly, at the floor stand 32, a controller 50 is installed for controlling the swing motor 40 and the fan motor 21. Here, a remote control 60 may be installed on the controller 50 to enable a user to freely control the drying apparatus from a remote distance. Here, the remote control 60 may be a typical wired or wireless remote control.

In the following, a description of the function and effect of a drying apparatus for a pet configured as described above according to the present invention will be provided.

First, when power is supplied to the drying apparatus of the present invention, the rotating fan 20 within the main body case 10 is driven. Accordingly, cool airflow (natural airflow) or hot airflow is discharged through the outlet 22 according to manipulation of the controller 50. The swing motor 40 reciprocates to pivot the main body case 10 (enclosing the rotating fan 20 fixed to and rotated by the fan motor 21, and having the outlet 22 or the inlets) upward and downward within a predetermined angular range. Of course, only the inlets may be defined separately in the stand 30.

Specifically, the pivoting angle (θs) of the main body case 10 in FIG. 9 may be a predetermined angular range over which hot air is discharged onto the entire body of a pet through reciprocal pivoting. Here, a user may, of course, manually use the main body case 10 by grasping a portion of the main body case 10 and fixing it at a suitable angle. That is, the main body case 10 is capable of being both reciprocally pivoted within a suitable discharging angular range and being fixed at a certain angle.

Because the discharging angle of the main body case 10 may thus be manually fixed or automatically pivoted within a predetermined range, a user can grasp a pet with one hand and arrange the hairs (fur) of the pet by grasping a tool such as a brush with the other hand.

Here, as a method for pivoting the main body case 10 upward and downward over a predetermined angular range, electric signals for rotating a low rpm (preferably 4 to 6 rpm) motor reciprocally forward and in reverse, or performing reciprocal rotation within a set range through a driving cam or gear assembly, may be employed. The main body case 10 may be pivoted within a set angular range through the above-driven swing motor 40 so that a user can dry a pet using both hands. Accordingly, drying can be facilitated, and drying time can be reduced. In other words, in order to blow air over a wide area, the present invention pivots the main body case 10 with the swing motor 40 to automatically control the discharged angle of air.

When the above-described user operates the main body case 10 manually instead of operating it automatically, the user can, of course, use the apparatus manually by grasping a portion of the main body case 10 and fixing the main body case 10 at a suitable upward or downward position. When operating manually, a separate manual knob (not assigned a reference number in the drawings) may be configured at one end of the main body case 10 to facilitate a user's grasping of the case.

Referring to FIG. 12, a rotating stand that can manually manipulate the main body case 10 may be configured with a tension ball 72 installed inside a side surface of the main body case 10 to be elastically supported by spring 74 and having a portion thereof exposed to the outside, and a plurality of latching recesses 73 defined at predetermined intervals in a side surface of the bridge stand 31 in corresponding positions to the tension ball 72 such that the latter can be seated therein. With this configuration, when a user dries a pet, a separate manual knob may be provided to allow a user to grasp a portion of the main body case 10 and rotate it to a desired direction in order to set the angle of discharge, so that the tension ball 72 latches and is seated in a latching recess 73, thereby fixing the outlet 22 at a predetermined angle.

That is, the user can use the apparatus after adjusting the main body case 10 to a desired angle to fix the direction of the outlet 22. Accordingly, the product can be simplified to reduce product cost, and drying can be performed not only across a pet's entire body, but also concentrated on extremities such as the pet's feet. Thus, by adopting manual and automatic methods for configuring a pivoting supporting member for pivoting the main body case 10, a user can, of course, use the apparatus by optionally switching between automatic and manual modes.

The stand 30 may be configured with a bridge support 31 that supports the main body case 10 and is provided with an air inlet 22, and a floor stand 32 with a built-in electronic control member.

Referring to FIG. 13, in order to enable at least one of the bridge stand 31 and the floor stand 32 that is supported on a floor surface to pivot laterally within a predetermined angular range, the stand 30 may be configured to be reciprocally rotated left and right over a predetermined angle by an electric driver such as a motor 80, or may be configured with a known typical driver to allow a user to manually rotate the stand 30 left and right to a desired angle.

In another embodiment for rotating the drying apparatus of the present invention to the left and right, a method for manually driving the stand to the left and right may include, as shown in FIG. 11, a tension ball provided on a side surface of the floor stand 32 and supported by a spring to partially be exposed to the outside, and a plurality of latching recesses defined in an outer side surface of the floor stand 32 to correspond to the tension ball.

Moreover, the stand 30 as that in FIG. 13 may be provided with a height adjusting member that enables vertical height adjustment with respect to a floor surface on which the bridge stand 31 or the floor stand 32 is supported to, or course, adjust the height of the apparatus (specifically, the height of the outlet 22) according to the size of a pet; or the stand may be configured with foldable legs 90 installed on the undersurface of the floor stand 32 to fold or extend the foldable legs 90 according to requirements to adjust height according to the size of a pet. Of course, the bridge stand 31 and the floor stand 32 may be integrally formed.

Referring to FIG. 10, the present invention may be provided with a separate inlet cover 18 on the front surface of the air inlet 17 to enable a functional sanitary filter 19 to be mounted in a replaceable manner. Accordingly, if the apparatus is used in a polluted environment, infiltration of impurities into the drying apparatus of the present invention during suctioning of external air through rotation of the rotating fan may be prevented in order to discharge better quality air.

### INDUSTRIAL APPLICABILITY

Although the present invention has been illustrated and described with reference to a number of specific exemplary embodiments above, the present invention is not limited to the above-described embodiments, and those having ordinary skill in the art to which the present invention relates will easily be able to implement various modifications and alterations without departing from the spirit and scope of the present invention as set forth in the appended claims below.

1. A drying apparatus, which discharges air to dry fur, the drying apparatus comprising:
a main body case defining an outlet and an inlet and comprising a heating member installed within;
a cross-flow fan installed in a length direction within the main body case, and rotated by a fan motor; and
a stand supporting the main body case in a continuous state, and provided with a manual knob for pivoting the main body case to a predetermined angle.

2. The drying apparatus of claim 1, wherein the manual knob comprises a tension ball installed in a side surface thereof and elastically supported to be partially exposed to an outside, and the stand comprises a plurality of latching recesses defined at predetermined intervals along a side surface of the stand to correspond to and seat the tension ball.

3. A drying apparatus, which discharges air to dry fur, the drying apparatus comprising:
a main body case provided with an air outlet and a heating member within;
a rotating fan installed within the main body case and rotated by a fan motor; and
a stand supporting the main body case in a continuous state, and provided with a pivoting supporting member capable of automatic or manual pivoting of the main body case upward and downward.

4. A drying apparatus, which discharges air to dry fur, the drying apparatus comprising:
a main body case provided with an air outlet and a heating member within;
a rotating fan installed within the main body case and rotated by a fan motor; and
a stand defining a plurality of latching recesses at predetermined intervals,
wherein the main body case is provided with a tension ball in a side surface thereof to be partially exposed to an outside, and the latching recesses are defined to correspond to and seat the tension ball, such that the main body case is pivotable by a predetermined angle.

5. The drying apparatus of claim 3, further comprising a swing motor installed on one end of the main body case to automatically pivot the main body case.

6. The drying apparatus of claim 3, wherein the rotating fan is a sirocco fan installed in a longitudinal direction to rotate in the main body case.

7. The drying apparatus of claim 3, wherein the stand comprises a tension ball installed in a side surface thereof to be elastically supported and partially exposed to an outside, and the main body case defines a plurality of latching recesses at predetermined intervals on a side surface thereof to correspond to and seat the tension ball, such that the pivoting supporting member is manually operated.

8. The drying apparatus of claim 3, wherein the stand is provided with a controlling member enabling vertical height adjustment or lateral pivoting of the stand.

9. The drying apparatus of claim 3, wherein the stand is provided with an electronic controlling member.

10. The drying apparatus of claim 9, wherein the stand comprises: a bridge stand supporting the main body case, and provided with an air inlet; and a floor stand having the electronic controlling member built in.

11. The drying apparatus of claim 10, further comprising a sanitary filter provided at a front of the air inlet.

12. The drying apparatus of claim 4, further comprising a swing motor installed on one end of the main body case to automatically pivot the main body case.

13. The drying apparatus of claim 4, wherein the rotating fan is a sirocco fan installed in a longitudinal direction to rotate in the main body case.

14. The drying apparatus of claim 4, wherein the stand is provided with a controlling member enabling vertical height adjustment or lateral pivoting of the stand.

15. The drying apparatus of claim 4, wherein the stand is provided with an electronic controlling member.

16. The drying apparatus of claim 15, wherein the stand comprises: a bridge stand supporting the main body case, and provided with an air inlet; and a floor stand having the electronic controlling member built in.

17. The drying apparatus of claim 16, further comprising a sanitary filter provided at a front of the air inlet.
